(19) United States
(12) Patent Application Publication
(10) Pub. No.: US 2021/0284558 A1
(43) Pub. Date: Sep. 16, 2021

(54) COMPOSITION AND METHOD FOR RECOVERY AND/OR BIOREMEDIATION OF OIL SPILLS AND/OR HYDROCARBONS

(71) Applicant: BIOSORBE AB, Karlstad (SE)

(72) Inventors: Anna OTTENHALL, TÄBY (SE); Monica EK, HÄGERSTEN (SE); Johan SIDENMARK, VALLENTUNA (SE); Clas TEGELSTRAND, VÄSTERÅS (SE); Erik JOSEPHSSON, ENSKEDE (SE); Lars MELIN, STOCKHOLM (SE)

(73) Assignee: BIOSORBE AB, Karlstad (SE)

(21) Appl. No.: 17/258,193

(22) PCT Filed: Jul. 12, 2019
(86) PCT No.: PCT/SE2019/050690

§ 371 Date: Jan. 6, 2021

(30) Foreign Application Priority Data
Jul. 13, 2018 (SE) 1850897-8

(51) Int. Cl. C02F 3/34; C02F 1/28; C09K 3/32

(52) U.S. Cl. CPC C02F 3/344; C02F 2101/32; C09K 3/32; C02F 1/288

(57) ABSTRACT

A composition and method for recovery and/or bioremediation of oil spills and/or hydrophobic hydrocarbons includes (a) cellulosic material, (b) a charged polymer adsorbed to the cellulosic material, and optionally (c) microorganisms combined with the polymer and/or cellulosic material.

### FIELD OF INVENTION

The present invention relates to a composition and method for recovery and/or bioremediation of oil spills and/or hydrophobic hydrocarbons, the composition comprising: (a) cellulosic material, (b) a charged polymer adsorbed to said cellulosic material, and optionally (c) microorganisms combined with said polymer and/or cellulosic material.

### BACKGROUND OF THE INVENTION

An oil spill is the release of a liquid petroleum hydrocarbons, synthetic hydrocarbons and/or biological hydrocarbons into the environment, especially the marine ecosystem, due to human activity, and is a form of pollutant. The term is usually given to marine oil spills, where oil is released into the ocean or coastal waters, but spills may also occur on land and on other surfaces. Oil spills may be due to releases of crude oil from tankers, offshore platforms, drilling rigs and wells, as well as spills of refined petroleum products (such as gasoline, diesel) and their by-products, heavier fuels used by large ships such as bunker fuel, or the spill of any oily refuse or waste oil.

Many oils and hydrocarbons are pollutants which when introduced into the environment results in undesired effects. Unfortunately, oils and hydrocarbons give rise to soil pollution and water pollution which adversely effects the ecosystems in soil and water.

Moreover, pollutions due to oils, hydrocarbons and pollutants are also caused by mining, small and heavy industries, corrosion of underground storage tanks and piping, Industrial accidents, leakage from vehicles and machines as well as waste disposal such as but not limited to (i) oil and fuel dumping, (ii) direct discharge of industrial wastes to the soil, and (iii) discharge of sewage. According to some sources, pollution of air, water and soil killed 9 million people in 2015. More importantly, the impact on animals and ecosystems are even more severe. Hence, there an urgent need for an effective product or method for recovering and/or degrading pollutants.

Unfortunately, cleanup and recovery from oil spills, hydrocarbons and pollutants is difficult and depends upon many factors, including the type of material spilled, the temperature of the water/soil/surface (affecting evaporation and biodegradation), and the types of shorelines and surfaces involved.

Methods for cleaning up oil spills, hydrocarbons and pollutants include: bioremediation (EP3150698, GB1353682, U.S. Pat. No. 5,486,474 and WO06018306), controlled burning, dispersants for dissipating oil slicks, dredging, skimming, solidifying, vacuuming and then centrifuging, and beach raking.

However, the physical cleanup methods (i.e. dredging, skimming, solidifying, vacuuming and then centrifuging, and beach raking) of oil spills are expensive and time consuming. Moreover, the method of using controlled burning causes environmental pollution and is risky if done in strong wind. Furthermore, the use of chemical methods such as dispersant and detergents result in dispersed oil droplets which infiltrate into deeper water and can lethally contaminate coral. Bioremediation which involves use of microorganisms has advantages; however, there is no effective method of collecting the microorganisms and the compounds which are produced by the microorganisms. Solidifying which involves the use of dry ice pellets has some advantages; however, it is expensive as well as logistically difficult to spread dry ice over large oil spills, especially in warm climates. Hence, there is a need for an alternative compositions and method for recovery and bioremediation of oil spill.

### General Description of the Invention

The general objects of the present invention is to provide compositions and methods for recovery and/or bioremediation of oil spills and hydrophobic hydrocarbons that are cost-efficient, provide fast processing, that are environmentally friendly, have a high absorption capacity compared to previous technologies and admit simple recovery of absorbed material. It is an important object of the invention to obtain a composition that admits a high retention of the absorbed material throughout extending periods before collecting and recovering the oil spills and/or hydrophobic hydrocarbons. It is also desirable to obtain compositions and methods that effectively operable in high salt concentrations and various environments, such as soil, water and on various wet or dry surfaces.

In a general aspect, the present invention is directed to attain the objects of the invention relates to an absorbent composition for recovery and/or bioremediation of oil spills and/or hydrophobic hydrocarbons, the composition comprising: a) cellulosic material, b) at least one layer of a charged polymer adsorbed to said cellulosic material, and c) optionally microorganisms combined with said polymer and/or cellulosic material.

The charged polymer is preferably a polyelectrolyte selected from polyvinylamine (PVAm), polyacrylamide, polyacrylic acid (PAA), polymethacrylic acid, chitosan, cationic gelatin, poly DADMAC, polyallylamine, polyethylenimine, anionic nanocellulose, sodium lignin sulfonate, sodium polyacrylate, anionic polyacrylamide, anionic glyoxalated polyacrylamide, poly-(sodium styrene sulphonate) and/or poly(vinylphosphonic acid). More preferably at least one polyelectrolyte is polyvinylamine (PVAm) including unmodified PVAm or PVAm modified with, straight or branched and optionally substituted alkyl chains, preferably PVAm is unmodified.

In one embodiment, the absorbent composition as previously defined comprised a first layer of polyvinylamine (PVAm).

In one embodiment, the absorbent composition as previously defined comprises a single of layer of polyvinylamine (PVAm).

In one embodiment, the absorbent composition as previously defined comprises multiple layers of consecutive cationic and anionic polyelectrolytes, such as three layers of PVAm-PAA-PVAm.

The cellulosic material generally comprises cellulose fibers, preferably derived from wood, crops, waste paper, or rags.

In one embodiment, the absorbent compositions as previously defined may have a cellulosic material that comprises pulp, wherein said pulp preferably comprises chemical pulp, kraft pulp, sulfite pulp, semi-chemical pulp, mechanical pulp, thermomechanical pulp (TMP), chemithermomechanical pulp (CTMP), non-wood pulp and/or recycled pulp, more preferably the cellulosic material comprises CTMP.

The Absorbent compositions as previously defined can comprise microorganisms selected from bacteria, fungi and archaea, preferably the microorganisms comprise archaea.

The Absorbent compositions as previously defined will have a higher affinity for oil than water.

The present invention also is directed to methods of preparing a composition for recovery and/or bioremediation of oil spill and/or hydrophobic hydrocarbons comprising the steps of: (a) providing a cellulosic material, preferably said cellulosic material is disintegrated, (b) adsorption of a polymer to said cellulosic material, and optionally (c) combination with microorganisms to the product of step (b).

In one embodiment of the method, said cellulosic material is disintegrated before step (a), preferably said cellulosic material is wetted before being disintegrated.

In one embodiment, said adsorption is chemical adsorption or physical adsorption.

In one embodiment, said adsorption is physical adsorption and the polymer is loaded either a single layer or in multiple layers by for example using layer-by-layer method.

In another aspect, the invention is directed to a method for recovery and/or bioremediation of oil spills and/or hydrophobic hydrocarbons, comprising the steps of: a) contacting oil spills and/or hydrophobic hydrocarbons with a composition according to any previous definition, b) admitting the composition to absorb the oil spills and/or hydrophobic hydrocarbons; and c) optionally collecting the composition.

Preferably, when performing the method, the absorbent composition absorbs at least its double weight following as result of the contacting step.

The method can be performed in water or on a wet surface. Suitably in a sea, the ocean, rivers, lakes, ponds, damp soil etc. or contaminated wet surfaces. Alternatively, the method is performed on a dry surface, i.e. a surface essentially free from water.

The methods as described can further include a step of collecting the composition from the water environment or the surface and for example transporting it to a suitable place in order to finally recover the absorbed oils spill and/or hydrophobic hydrocarbon with a compressing step. The so recovered material can processed with conventional technologies.

Further according to the method the inventive composition admits a high retention of the absorbed material (i.e. the oils pill and/or hydrophobic hydrocarbons) throughout extended periods before collecting the composition. In this context retention means that the absorbed material does not essentially leak back from the composition. Preferably the composition is capable of such retention for at least 1 day such as 1 to 10 days, preferably several weeks, and more preferably several months. The high absorption and retention capacity of the compositions and methods of the invention is highly advantageous to remedy environmental pollution, such as marine pollution.

In the present invention, the term “bioremediation” refers to the use of microorganisms for degrading oil spills and hydrophobic hydrocarbons which pose environmental and human hazards. Bioremediation may involve the use many different microorganisms to complete the degradation process in soil and/or water.

In the present Invention, the term “recovery” means regaining, absorbing and/or collecting.

In these general contexts of the invention, the term “oil spill” shall be given a broad meaning as any spill derived from petroleum and fossil fuels including crude oil, gasoline, diesel, kerosene spills and various base and process oils. Moreover, the expression “oils spill” also includes synthetic oils, non-fossil fuels and plant-derived oils. An oil spill may be an oil spill in water, in/on soil or on a surface (e.g. on roads and in a factory or industry). Further “oil spill” in the meaning of the present invention can also be cooking oils, fats and greases present in fans or other ventilation equipment or sewage systems, as used both in industrial and domestic systems for production of food. The term “hydrophobic hydrocarbon” shall be regarded broadly and include agents such as (a) alkanes, which either branched or straight, and optionally substituted, (b) aromatic hydrocarbons, preferably as benzene, toluene, ethylbenzene, xylene, benzoate, chlorobenzoate and p-hydrobenzoic acid, (c) polyaromatic hydrocarbons (PAHs), preferably naphthalene, anthracene, fluorene, pyrene, benzopyrene, phenanthrene, biphenyl and biphenyl, (d) nitrogen compound, preferably ammonia, nitrite, nitrate as well as hydrocarbons containing nitrogen, and (e) hydrocarbons containing sulfur.

According to the present invention, the microorganisms shall be combined with said charged polymer and/or cellulosic material. In the broadest meaning, these terms mean that the microorganism shall be physically present in the confinement of the same composition which means that the charged polymer and/or cellulosic material can be combined with the microorganisms by a number of technologies such as wet and dry mixing, surface adsorption and various immobilization technologies including crosslinkers.

Microorganisms can be immobilized to the polymer adsorbed cellulosic material by mixing the biological material (i.e. microorganisms) with the polymer adsorbed cellulosic material. The binding of the biological material to the polymer adsorbed cellulosic material can be physical, ionic and/or covalent in nature. Said binding can be achieved for example by polyelectrolytes optionally in combination with other compounds.

Additionally, the immobilization may involve growing the microorganisms on the polymer adsorbed cellulosic material. If bacteria are used as microorganisms then biofilms may preferably form on the polymer adsorbed cellulosic material.

Moreover, a mixture of biological material and polymer adsorbed cellulosic material is contacted with a cross-linking polymer such as alginate or nanocellulose. Bacteria and archaea, or mixtures thereof, are preferably cross-linked in an aqueous solution comprising an ionic cross-linker. The cross-linker may comprise Ca²⁺, Al³⁺, Ba²⁺ and Sr²⁺. Fungi may also be cross-linked by a similar process.

Suitable bacteria, archaea and/or fungi for the composition of the present invention are such organisms which degrade compounds found in oil spills may be used in the present invention as microorganisms.

The composition according to the present invention preferably comprises microorganisms which are resistant to NaCl solutions. In some cases, the rate of degrades of one or more of the compounds mentioned above may be increased with increased NaCl concentration. Concentrations up to 4 M NaCl or more are possible. Some examples of salt concentrations are <1M NaCl, <2M NaCl, <3M NaCl and <4M NaCl.

Some examples of bacteria which may be used are selected from Pseudomonas putida, Pseudomonas oleovorans, Dechloromonas aromatic, Nitrosomonas europaea, Nitrobacter hamburgensis, Paracoccus denitrificans, Deinococcus radiodurans, Methylibium petroleiphilum and/or Alcanivorax borkumensis. Halophile bacteria such as Salinibacter ruber, Chromohalobacter salexigens, Halothermothrnx orenii and/or Halorhodospira halophile may also be used.

Some examples of fungi which may be used are selected from Aureobasidium pullulans, Myrothecium vemucaria, Cladosporium cladosporioides, Saccharomyces cerevisiae, Aspergillus, Rhodotorula, brown-rot fungi and/or white rot fungi. Some examples of white rot fungi which may be used are Phanerochaete chrysosporium, Pleurotus ostreatus, Bjerkandera adjusta and Trametes versicolor. More generally, white rot fungus from the Phanerochaete, Phlebia, Trametes, Pleurotus and/or Bjerkandera genera may also be used.

Some examples of archaea which may be used are selected from Archaeoglobus fulgidus and/or halophilic archaea such as haloarchaea strains belonging to the genus Halobacterium (e.g. Haloferax volcanii), Haloferax (e.g. Haloferax denitrificans), Haloarcula (e.g. Haloarcula mansmortui and Haloarcula quadrata) and/or Halococcus. Archaea such as Halogeometricum borinquense, Haloquadratum walsbyi, Halothermothrix oreni Natronobacterum magadii, Natronobacterium gregoryi and Natronomonas pharaonis may also be used. Further preferred archaea are sulfate-reducing archaea and/or hyperthermophilic archaea.

### Detailed and Exemplifying Description of the Invention

### BRIEF DESCRIPTION OF DRAWINGS

FIG. 1 shows the amount (g/g pulp) of diesel and diesel/H₂O (diesel mixed with water) which is absorbed by unmodified kraft pulp and mechanical pulp.

FIG. 2 shows from left to right the behavior unmodified mechanical pulp (Ref), 1L-PVAm layered kraft pulp (1L) and 3L-PVAm/PAA/PVAm layered kraft pulp (3L) in water.

FIGS. 3 and 3b show absorption of water and oil, respectively.

FIG. 4 shows the filtration of a mixture comprising 10 ml hydraulic oil and 30 ml water through 0.5 g unmodified mechanical pulp (REF) and 1L-PVAm layered mechanical pulp (1L).

### EXAMPLES

### Example 1

Fiber Disintegration

Dried bleached kraft pulp (KRAFT) and dried unbleached mechanical pulp (MP) were resuspended in deionized water and disintegrated. One layer of PVAm or three layers of PVAm/PAA were adsorbed onto the resulting fiber products as described below.

Fiber Modification—1 Layer (i.e. Example of Single Layer)

A single layer of the polyelectrolyte PVAm was adsorbed onto the fiber products at a fiber consistency of 0.25% w/w, i.e. a 0.25% polymer w/w was added to the cellulose. The single layer of PVAm were adsorbed onto the fibers at a polymer concentration of 0.10 g/L and a NaCl concentration of 100 mM under constant stirring at pH 9.5. Excess polymer was removed by rinsing the sample with deionized water. Finally, the fibers were rinsed with acidic water (pH<3.5) prior to drying.

Fiber Modification—3 Layers (i.e. Example of Multi-Layer)

Three layers of the PVAm/PAA/PVAm were adsorbed onto the fiber products at a fiber consistency of 0.5% WW. The polyelectrolyte multilayer of PVAm were adsorbed onto the fibers at a polymer concentration of 0.10 g/L and a NaCl concentration of 100 mM under constant stirring. The adsorption scheme was as follows: PVAm (pH 9.5), PAA (pH 3.5) and PVAm (pH 9.5). After each step, excess polymer was removed by rinsing the sample with deionized water. Finally, the fibers were rinsed with acidic water (pH<3.5) prior to drying.

Hence in summary, the cellulosic material (i.e. pulp) is modified by adding polymer, salt and adjusting pH for adsorption of the polyelectrolyte to the cellulosic material.

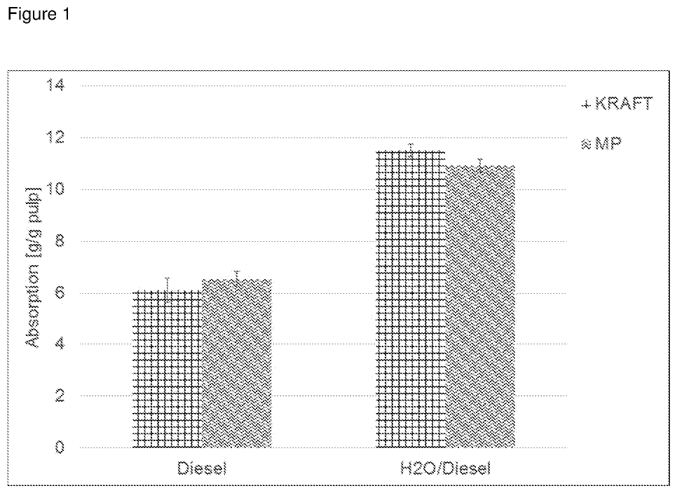

The fiber samples resulting from the above described 1- and 3-layer modifications are in FIGS. 1-5, designated according to the number of layers they contained, e.g. 3L fibers possess three layers of polymers, i.e. PVAm/PAA/PVAM. Similarly, 1L fibers possess one layers of polymers, i.e. PVAm.

### Results

FIG. 1 shows the amount (g/g pulp) of diesel and diesel/H₂O (diesel mixed with water) which is absorbed by unmodified kraft pulp and mechanical pulp. Both pulps have similar absorptions. Similar results were observed for 3-layered kraft pulp (data not shown).

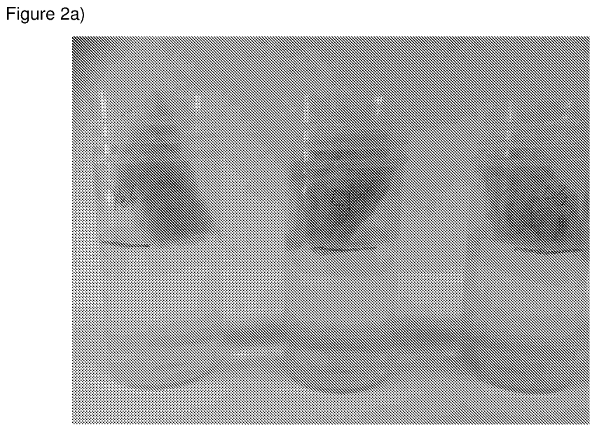

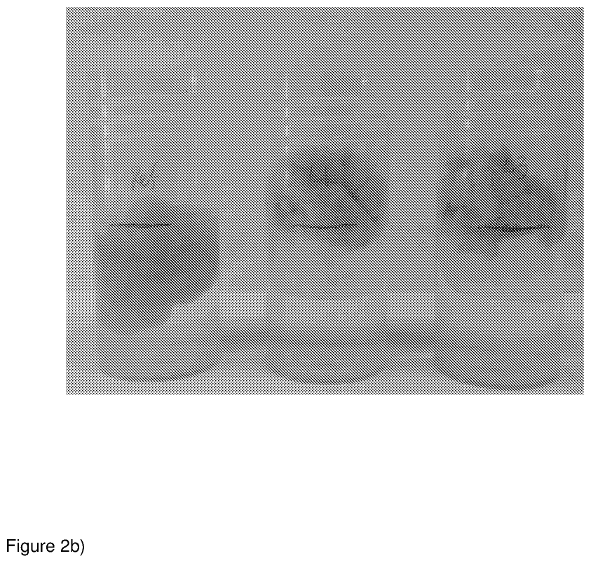

FIG. 2 shows from left to right the behavior unmodified mechanical pulp (Ref), 1L-PVAm layered kraft pulp (1L) and 3L-PVAm/PAA/PVAm layered kraft pulp (3L) in water. FIG. 2a shows the behavior after 0 minutes, i.e. at the start of the test, while FIG. 2b shows the behavior after 1 day. The results clearly show that most of the 1-PVA layered kraft pulp and 3L-PVAm/PAA/PVAm layered kraft pulp float on the surface of water while most of the unmodified mechanical pulp is below water-level. Hence, due to the surprising and unexpected technical effects of 1-PVAm layered kraft pulp and 3L-PVAm/PAA/PVAm layered kraft pulp, these modified kraft pulps will be easier to collect after recovery and/or bioremediation of oil spills in water. The collected pulps comprising recovered oil can be used for e.g. producing energy.

Table 1 relates to absorption of three types of oils and hydrocarbons using unmodified mechanical pulp (Ref pulp), 1L-PVAm layered kraft pulp (1L pulp) and 3L-PVAm/PAA/PVAm layered kraft pulp (3L pulp) during an absorption time of 1 minute. The results clearly show that modified pulps surprisingly absorb more than twice as much petroleum diesel, hydraulic oil and motor oil when compared to unmodified pulp.

TABLE 1

| | Ref pulp | 1L pulp | 3L pulp |
|---|---|---|---|
| Oil | (g/g pulp) | (g/g pulp) | (g/g pulp) |
| Petrol diesel | 2.0 ± 0.3 | 5.9 ± 0.3 | 6.2 ± 0.4 |
| Hydraulic oil | 3.0 ± 0.1 | 6.7 ± 0.4 | 6.7 ± 0.3 |
| Motor oil | 3.2 ± 0.4 | 7.2 ± 0.5 | 7.7 ± 0.7 |

Table 2, below shows the average absorption of liquid per gram of kraft pulp in different oil and water mixtures.

TABLE 2

| | Diesel/water | Hydraulic oil/water | Motor oil/water |
|---|---|---|---|
| Pulp | mixture | mixture | mixture |
| sample | [g/g pulp] | [g/g pulp] | [g/g pulp] |
| REF | 3.9 ± 0.8 | 4.3 ± 0.1 | 5.0 ± 0.4 |
| L1 | 9.0 ± 0.3 | 9.4 ± 0.4 | 8.6 ± 0.8 |
| L3 | 9.7 ± 0.2 | 8.3 ± 0.8 | 8.9 ± 0.8 |

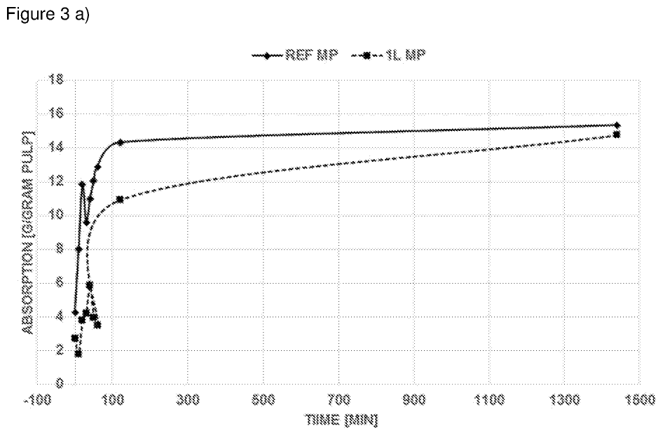

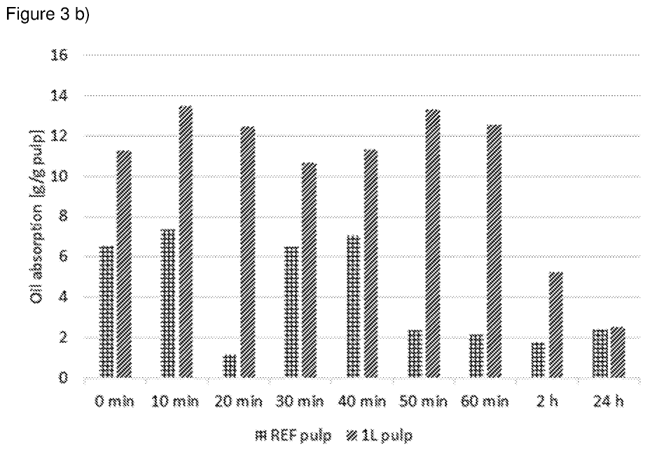

FIG. 3a shows absorption of water by unmodified mechanical pulp (REF MP) and 1L-PVAm layered mechanical pulp (1L MP). The graph indicates that unmodified mechanical pulp (REF MP) absorbs more water than 1L-PVAm layered mechanical pulp (1L MP). The graph further indicates that unmodified mechanical pulp (REF MP) absorbs water with a higher rate than 1L-PVAm layered mechanical pulp (1L MP).

FIG. 3b shows absorption of oil after the pulps have been exposed to water for X minutes when using unmodified mechanical pulp (REF pulp) and 1L-PVAm layered mechanical pulp (1L pulp). The graph indicates that 1L-PVAm layered mechanical pulp (1L pulp) which has first been in water surprisingly and unexpectedly absorbs more oil than unmodified mechanical pulp (REF pulp).

FIGS. 3a and 3b clearly and unambiguously shows that 1L-PVAm layered mechanical pulp is more advantageous than unmodified mechanical pulp as a composition for recovery of oil and hydrocarbons since the 1L-PVAm layered mechanical pulp has more affinity for oil than water. Hence, the modified kraft pulps can recover more oil spills and hydrocarbons than unmodified pulps. In other words, the recovery of oil spills and hydrocarbons will be more efficient with 1L-PVAm layered mechanical pulp when compared to unmodified mechanical pulp. This surprising and unexpected effect has not been described in any prior art documents. As already indicated, collected pulps which comprise recovered oil can be used for e.g. producing energy.

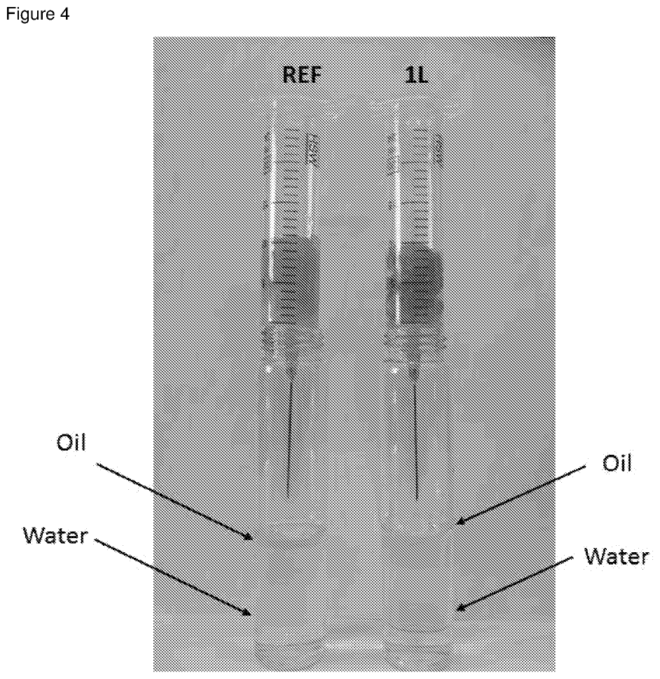

FIG. 4 shows the filtration of a mixture comprising 10 ml hydraulic oil and 30 ml water through 0.5 g unmodified mechanical pulp (REF) and 1L-PVAm layered mechanical pulp (1L). The figure shows that the mixture which has been filtered through the unmodified mechanical pulp (REF) has about 3 mm thickness of hydraulic oil at the surface of the water. As a contrast, the mixture which has been filtered through the 1L-PVAm layered mechanical pulp (1L) has about 1 mm thickness of hydraulic oil at the surface of the water. Consequently, the results clearly show that modified pulp (i.e. 1L-PVAm layered mechanical pulp) surprisingly has more affinity for oil than unmodified pulp since more oil has been captured by the modified pulp. In other words, the recovery oil spills and hydrocarbons will be more efficient with 1L-PVAm layered mechanical pulp when compared to unmodified mechanical pulp.

### Example 2

CTMP Pulp Absorption Test in Oil/Water

Chemo-thermo mechanical pulp (CTMP) fibers were modified with one layer of PVAm (L1) and with three layer PVAm-PAA-PVAm (L3) according to the method described in Example 1. The reference pulp, L1 and L3, 0.5 g of each, were immersed into the motor oil (10 ml) and motor oil/water mixture (15 ml H₂O and 6 ml motor oil) for 1 minute for each absorption test. The samples were then weighted after absorption. All the tests were conducted in triplicates.

Table 3, below show that the unmodified CTMP pulp absorbed 7.4 g motor oil per gram of pulp while both the modified pulps, L1 and L2, absorbed twice as much pure motor oil. This is a doubled absorption capacity compared to the kraft pulp tested in the previous absorption test. The reason might be that the lignin in mechanical pulp increased the hydrophobicity of the pulp, which gives the pulp a higher affinity for hydrophobic products like oil. The modified pulps, L1 and L3, absorbed almost the same amount of motor oil. This test showed that the CTMP pulps had a higher affinity for oil compared to kraft pulp and that a single layer of PVAm enables a suitable absorbent.

TABLE 3

| | | Motor oil/Water |
|---|---|---|
| Pulp | Motor oil | mixture |
| sample | [g/g pulp] | [g/g pulp] |
| REF | 7.4 ± 0.4 | 4.9 ± 2.2 |
| L1 | 14.4 ± 0.9 | 9.0 ± 0.3 |
| L3 | 14.2 ± 0.5 | 9.9 ± 0.3 |

### Example 3

Combination of Microorganisms and Absorbent

The modified pulp from Example 2 was used (L1 CTMP in Example 2) together with reference pulp (CTMP). The microorganisms used comprise natural oil consuming Archaea and were obtained from Oppenheimer Biotechnology, Inc., (https://www.obio.com/index.htm) as the product Piranha®. The microorganisms was added to the pulp absorbent by shaking 1 g of pulp 1 g with 100 mg grinded nutrient mixture and 100 mg microorganism fixated on starch. The microorganism containing absorbent was added to a mixture of 10 ml hydraulic oil and 90 ml water. Six different combinations of the experiment were tested in duplicates, see Table 4, below for setup. The bottles were shaken and sealed. After 2 weeks of incubation at room temperature the solution was analyzed for hydrocarbons. The absorbent was removed from the mixture and dried for 2 days in the fume hood before it was weighted.

TABLE 4

| Experiment group | 1 | 2 | 3 | 4 | 5 | 6 |
|---|---|---|---|---|---|---|
| Hydraulic oil & water | X | X | X | X | X | X |
| (1:9) | | | | | | |
| Microorganism/starch | | X | | X | | X |
| 100 mg | | | | | | |
| Nutrients 100 mg | | X | | X | | X |
| REF CTMP 1 g | | | X | X | | |
| L1 CTMP 1 g | | | | | X | X |

After 2 weeks incubation there was a difference in the flasks containing pulp with and without microorganisms added. The pulp in flask 4 and 6, with microorganisms added in the pulp, had started to fall apart and fibers were seen in the bottom of the flasks. The L1 pulp without added microorganisms was still floating collected in lumps. The microorganisms might affect the structure of the pulp, perhaps it starts to degrade the pulp and the absorbed hydrocarbons as well as the added polymers in the modification.

The results of the hydrocarbon analysis indicated that the toluene concentration decreased as a result of the addition of microorganisms (flasks 2, 4 and 6) and that the lowest toluene concentration was found in the L1-modified pulp (flask 6).

1.-15. (canceled)

16. An absorbent composition for recovery and/or bioremediation of oil spills and/or hydrophobic hydrocarbons, the composition comprising:
cellulosic material, comprising semi-chemical pulp, mechanical pulp, thermomechanical pulp (TMP) or chemithermomechanical pulp (CTMP);
at least one layer of a charged polymer adsorbed to said cellulosic material, wherein the charged polymer is a polyelectrolyte selected from polyvinylamine (PVAm), polyacrylamide, polyacrylic acid (PAA), polymethacrylic acid, chitosan, cationic gelatin, poly DADMAC, polyallylamine, polyethylenimine, anionic nanocellulose, sodium lignin sulfonate, sodium polyacrylate, anionic polyacrylamide, anionic glyoxalated polyacrylamide, poly-(sodium styrene sulphonate) and/or poly(vinylphosphonic acid); and optionally
microorganisms combined with said polymer and/or cellulosic material.

17. The absorbent composition according to claim 16, wherein at least one polyelectrolyte is polyvinylamine (PVAm) including unmodified PVAm or PVAm modified with, straight or branched and optionally substituted alkyl chains, preferably PVAm is unmodified.

18. The absorbent composition according to claim 17, comprising a first layer of polyvinylamine (PVAm).

19. The absorbent composition according to claim 17, comprising a single of layer of polyvinylamine (PVAm).

20. The absorbent composition according to claim 18, comprising multiple layers of consecutive cationic and anionic polyelectrolytes, such as three layers of PVAm-PAA-PVAm.

21. The absorbent composition according to claim 16, comprising microorganisms selected from bacteria, fungi and archaea, preferably the microorganisms comprise archaea.

22. The absorbent composition according to claim 16, wherein said composition has higher affinity for oil than water.

23. A method for recovery and/or bioremediation of oil spills and/or hydrophobic hydrocarbons, comprising the steps of:
contacting oil spills and/or hydrophobic hydrocarbons with the composition according to claim 16;
admitting the composition to absorb the oil spills and/or hydrophobic hydrocarbons; and
optionally collecting the composition.

24. The method according to claim 23, wherein the composition absorbs at least its double weight following as a result of the contacting step.

25. The method according to claim 23, performed in water or on a wet surface.

26. The method according to claim 23, performed on a dry surface.

27. The method according to claim 23, comprising collecting the composition; and compressing the composition to recover said oil spill and/or hydrophobic hydrocarbons.

28. The method according to claim 23, comprising retaining the absorbed oil spills and/or hydrophobic hydrocarbons in the composition for at least on day before collecting the composition.
